(19) United States
(12) Patent Application Publication
(10) Pub. No.: US 2019/0130502 A1
(43) Pub. Date: May 2, 2019

(54) ON-DEMAND, IN PROCESS CUSTOM VISUALIZATION

(71) Applicant: NCR Corporation, Duluth, GA (US)

(72) Inventors: Alexander Michael Heavner, Sharpsburg, GA (US); Mehtab Chithiwala, Lawrenceville, GA (US); Michael Robert Dunn, Tucker, GA (US); Travis Andrew Massey, Marietta, GA (US); Brandon Michael Wright, Atlanta, GA (US); Laura Crosby, Atlanta, GA (US)

(21) Appl. No.: 15/797,157

(22) Filed: Oct. 30, 2017

(51) Int. Cl. G06Q 50/12; G06Q 20/32

(52) U.S. Cl. CPC G06Q 50/12; G06Q 20/325

(57) ABSTRACT

Various embodiments herein each include at least one of systems, devices, methods, and software that provides on-demand, in process custom visualization. For example, some such embodiments provide such solutions that enable customers to view an augmented reality presentation, which may be a three-dimensional or holographic view, of a product with any selected options at the discretion of the customer. One such embodiment in the form of a method includes presenting, via a visual output of an augmented reality device, a selectable menu of customizable items and customizable features thereof and receiving a selection of a customizable item and at least one customizable feature. This method further includes presenting, via the visual output of the augmented reality device, a view of the selected customizable item and each selected at least one customizable feature as the input is received.

### BACKGROUND INFORMATION

Today's marketplace is full of more product options than conceivable only 10 to 15 years ago. Further, many products also have their own configuration options. This is true for everything from hamburgers to automobiles and from bulldozers to tennis shoes. Maintaining models of each product type, let alone with each product within each of various options, has become difficult if not impossible.

At the same time, today's high-tech marketplace has become extremely competitive. Retailers and restaurants search for new ways to get the attention of distracted customers while offering them new, improved, and differentiated experiences.

### SUMMARY

Various embodiments herein each include at least one of systems, devices, methods, and software that provides on-demand, in process custom visualization. For example, some such embodiments provide such solutions that enable customers to view an augmented reality presentation, which may be a three-dimensional or holographic view, of a product with any selected options at the discretion of the customer.

One such embodiment in the form of a method includes presenting, via a visual output of an augmented reality device, a selectable menu of customizable items and customizable features thereof and receiving a selection of a customizable item and at least one customizable feature. This method further includes presenting, via the visual output of the augmented reality device, a view of the selected customizable item and each selected at least one customizable feature as the input is received.

Another method embodiment includes presenting, via a visual output of a device, a selectable menu of customizable items and customizable features thereof and presenting, via the visual output of the device, a view of a selected customizable item and a customizable feature based on input received by the device.

A further embodiment is in the form of a device. The device includes a processor, a wireless network interface, a display, an input, a memory, and instructions stored on the memory that are executable by the processor to perform data processing activities. The data processing activities may include presenting, via the display, a selectable menu of customizable items and customizable features thereof and a view of a selected customizable item and a customizable feature based on input received by the device. The data processing activities may further include receiving, via the input, order input with regard to the selected customizable item and customizable feature thereof and transmitting, via the wireless network interface, order data including data representative of the selected customizable item and selected customizable feature thereof to an order data processing service. Other data processing activities of some embodiments include receiving, via the input, at least one payment input command to provide payment for an order with regard to the received order input and transmitting, via the wireless network interface, the received payment data to a payment transaction processing service in response to receiving the at least one payment input command.

### BRIEF DESCRIPTION OF THE DRAWINGS

FIG. 1 is a logical block diagram of a system architecture, according to an example embodiment.

FIG. 2 is a block flow diagram of a method, according to an example embodiment.

FIG. 3 is a block flow diagram of a method, according to an example embodiment.

FIG. 4 is a block diagram of a computing device, according to an example embodiment.

### DETAILED DESCRIPTION

Various embodiments herein each include at least one of systems, devices, methods, and software that provides on-demand, in process custom visualization. For example, some such embodiments provide such solutions that enable customers to view an augmented reality presentation, which may be a three-dimensional or holographic view, of a product with any selected options at the discretion of the customer. Some embodiments are deployed upon HOLOLENS, available from MICROSOFT CORPORATION of Redmond Wash. to provide holographic views of products based on received selections of available products and selectable options therefor. For example, some embodiments may be deployed within a restaurant context. A solution in such embodiments may present a menu of food items including a burger. The options may include bun, cheese, and condiment options. As options are selected, the burger may be assembled and presented in a three-dimensional form to a wearer of the HOLOLENS device, other wearable device, or other augmented reality device, such as a mobile device. Similarly, a car or other items with selectable options may be presented within an environment as if it were really physically present.

These and other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

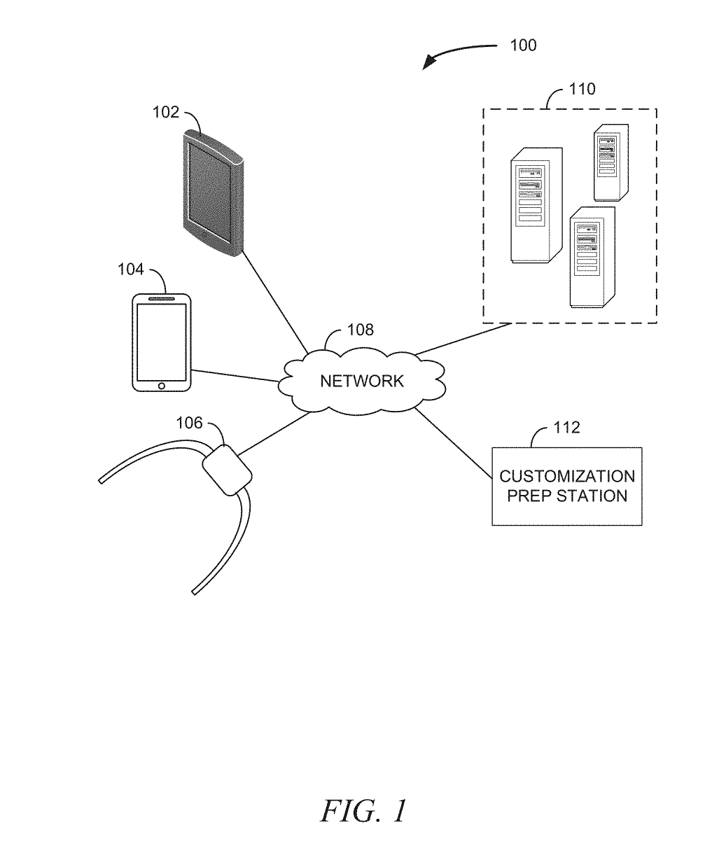

FIG. 1 is a logical block diagram of a system 100 architecture, according to an example embodiment. The system 100 is an example computing environment within which some embodiments may be deployed.

The system 100 may include one or more devices upon which users may utilize on-demand, in process custom visualization enabled apps/applications. These devices may include tablets 102, smartphones 104, wearable computing devices 107 that augment a live view of an environment with data (e.g., HOLOLENS), and other such devices. These devices may include apps that present a menu of products to select from and then a menu of configurable options for a selected product. As the user moves through the menus selecting a product and configuration options, a view of the product is presented within a live view of an environment where the device is located. The product may be presented as a three-dimensional item, or hologram, in some embodiments, such as when presented by a HOLOLENS or other similar device.

Each of the devices 102, 104, 106 may be connected to a network 108, such as the Internet, to interact with server systems 110 that may provide data, graphical, and order and purchase functions to the devices. The server systems 110 may also receive orders and transmit order data to customization prep station computer 112, such as in the kitchen of a restaurant for preparation of a hamburger, taco, or other menu item as may be customized on a device 102, 104, 106 and ordered through the server systems 110.

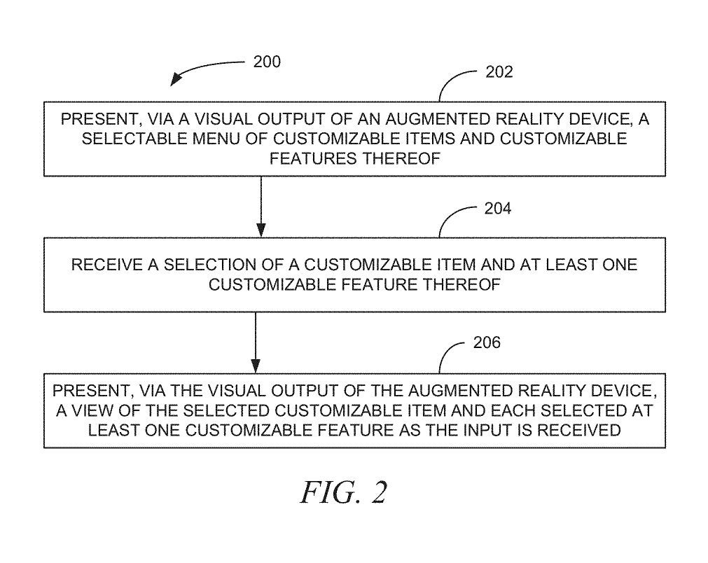

FIG. 2 is a block flow diagram of a method 200, according to an example embodiment. The method 200 is an example of an embodiment that may be implemented on a user or customer device, such as one or more of the devices 102, 104, 106 of FIG. 1.

The method 200 includes presenting 202, via a visual output of an augmented reality device, a selectable menu of customizable items and customizable features thereof. The method 200 further includes receiving 204 a selection of a customizable item and at least one customizable feature thereof and presenting 206, via the visual output of the augmented reality device, a view of the selected customizable item and each selected at least one customizable feature as the input is received.

Some such embodiments of the method 200 also include receiving an order input with regard to the selected customizable item and selected customizable features thereof. The method 200 then transmits order data including data representative of the selected customizable item and selected customizable features thereof to an order data processing service, such as the server systems 110 of FIG. 1. One such embodiment also includes receiving at least one payment input command to provide payment for an order with regard to the received order input and transmitting payment data to a payment transaction processing service in response to receiving the at least one payment input command.

In another embodiment of the method 200, the order data is transmitted via a network interface device of the augmented reality device over a network to the order data processing service. In one such embodiment, the customizable item is a customizable menu item offered by a restaurant. In this embodiment, the order data processing service may forward a portion of the order data to an order prep station (e.g., customization prep station 112 of FIG. 1) of a restaurant location where the selected customizable item with the selected customizable features thereof is to be delivered.

The visual output of the augmented reality device, in some embodiments of the method 200, is a visual output device for wear including a portion worn within a human line-of-sight. For example, the augmented reality device may be a human-worn computing device that is worn about the head, such as a HOLOLENS device. In some other embodiments, the augmented reality device is a mobile device and the visual output of the augmented reality device is a display of the mobile device.

In a further embodiment of the method 200, at least one customizable feature includes a variable, such as a measurement amount, a portion of a product such as a pizza to be covered by a topping, or another value. In some such embodiments of the method 200, receiving 204 the selection of the at least one customizable feature includes an input with regard to the variable.

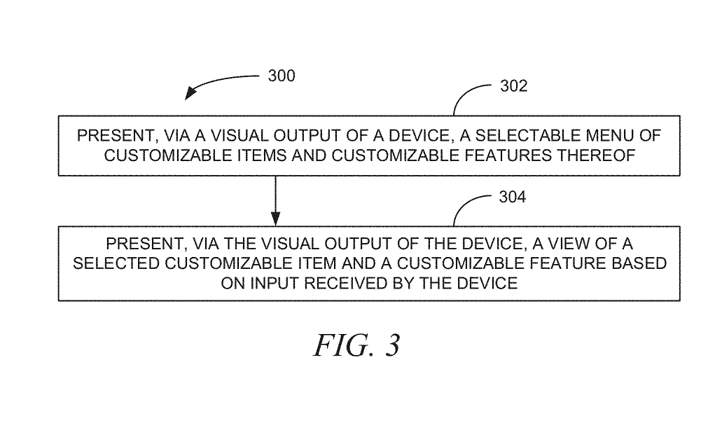

FIG. 3 is a block flow diagram of a method 300, according to an example embodiment. The method 300 is another example of a method that may be implemented on a user or customer device, such as one or more of the devices 102, 104, 106 of FIG. 1.

The method 300 includes presenting 302, via a visual output of a device, a selectable menu of customizable items and customizable features thereof and presenting 304, via the visual output of the device, a view of a selected customizable item and a customizable feature based on input received by the device.

Some embodiments of the method 300 further include receiving, by the device, order input with regard to the selected customizable item and customizable feature thereof and transmitting order data including data representative of the selected customizable item and selected customizable feature thereof from the device to an order data processing service. Such embodiments may then receive, by the device, at least one payment input command to provide payment for an order with regard to the received order input. The received payment data may then be transmitted by the device to a payment transaction processing service in response to receiving the at least one payment input command.

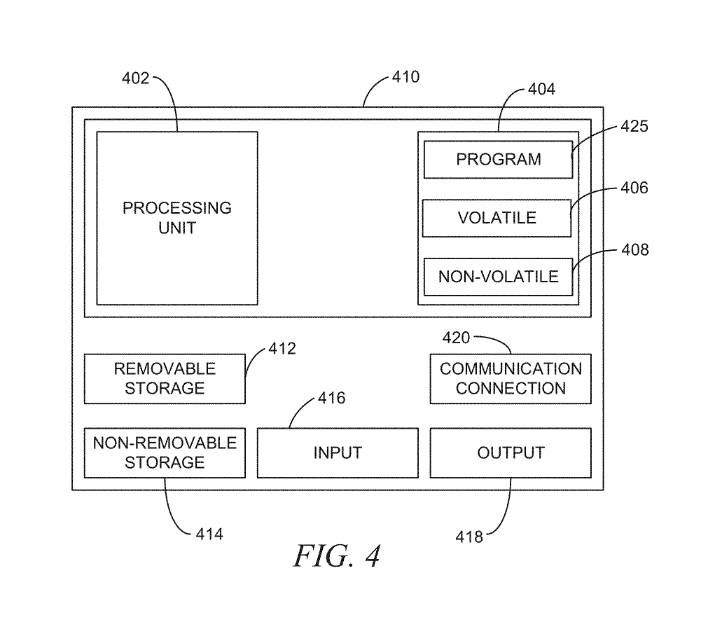

FIG. 4 is a block diagram of a computing device, according to an example embodiment. In one embodiment, multiple such computer systems are utilized in a distributed network to implement multiple components in a transaction based environment. An object-oriented, service-oriented, or other architecture may be used to implement such functions and communicate between the multiple systems and components. One example computing device is in the form of a voice device, such as the voice device 102 of FIG. 1. Another example computing device in the form of a computer 410, such as a computer on which voice processing services 110 or backend systems 106 may be deployed.

The computing device, such as the computer 410, may include a processing unit 402, memory 404, removable storage 412, and non-removable storage 414. Memory 404 may include volatile memory 406 and non-volatile memory 408. Computer 410 may include—or have access to a computing environment that includes—a variety of computer-readable media, such as volatile memory 406 and non-volatile memory 408, removable storage 412 and non-removable storage 414. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 410 may include or have access to a computing environment that includes input 416, output 418, and a communication connection 420. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 402 of the computer 410. A hard drive (magnetic disk or solid state), CD-ROM, and RAM are some examples of articles including a non-transitory computer-readable medium. For example, various computer programs 425 or apps, such as one or more applications and modules implementing one or more of the methods illustrated and described herein or an app or application that executes on a wearable computing device, an augmented reality capable headset, a voice device, a mobile device, or is accessible via a web browser, may be stored on a non-transitory computer-readable medium.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
presenting, via a visual output of an augmented reality device, a selectable menu of customizable items and customizable features thereof;
receiving a selection of a customizable item and at least one customizable feature thereof; and
presenting, via the visual output of the augmented reality device, a view of the selected customizable item and each selected at least one customizable feature as the input is received.

2. The method of claim 1, further comprising:
receiving an order input with regard to the selected customizable item and selected customizable features thereof; and
transmitting order data including data representative of the selected customizable item and selected customizable features thereof to an order data processing service.

3. The method of claim 2, further comprising:
receiving at least one payment input command to provide payment for an order with regard to the received order input; and
transmitting payment data to a payment transaction processing service in response to receiving the at least one payment input command.

4. The method of claim 2, wherein the order data is transmitted via a network interface device of the augmented reality device over a network to the order data processing service.

5. The method of claim 4, wherein:
the customizable item is a customizable menu item offered by a restaurant; and
the order data processing service forwards at least a portion of the order data to an order prep station of a restaurant location where the selected customizable item with the selected customizable features thereof is to be delivered.

6. The method of claim 1, wherein the visual output of the augmented reality device is a visual output device for wear including a portion worn within a human line-of-sight.

7. The method of claim 6, wherein the augmented reality device is a human-worn computing device that is worn about the head.

8. The method of claim 1, wherein the augmented reality device is a mobile device and the visual output of the augmented reality device is a display of the mobile device.

9. The method of claim 1, wherein:
at least one customizable feature includes a variable; and
receiving the selection of the at least one customizable feature includes an input with regard to the variable.

10. The method of claim 9, wherein the variable is a value amount.

11. A method comprising:
presenting, via a visual output of a device, a selectable menu of customizable items and customizable features thereof; and
presenting, via the visual output of the device, a view of a selected customizable item and a customizable feature based on input received by the device.

12. The method of claim 11, further comprising:
receiving, by the device, order input with regard to the selected customizable item and customizable feature thereof; and
transmitting order data including data representative of the selected customizable item and selected customizable feature thereof from the device to an order data processing service;
receiving, by the device, at least one payment input command to provide payment for an order with regard to the received order input; and
transmitting the received payment data by the device to a payment transaction processing service in response to receiving the at least one payment input command.

13. The method of claim 12, wherein:
the order data is transmitted via a network interface device of the device over a network to the order data processing service.

14. The method of claim 13, wherein:
the customizable item is a customizable menu item offered by a restaurant; and
the order data processing service forwards at least a portion of the order data to an order prep station of a restaurant location where the selected customizable item with the selected customizable features thereof is to be delivered.

15. The method of claim 11, wherein the visual output of the device is a visual output device for wear including a portion worn within a human line-of-sight.

16. The method of claim 15, wherein the device is a human-worn computing device that is worn about the head.

17. The method of claim 11, wherein the device is a mobile device and the visual output of the device is a display of the mobile device.

18. A device comprising:
a processor, a wireless network interface, a display, an input, a memory, and instructions stored on the memory that are executable by the processor to perform data processing activities comprising:
presenting, via the display, a selectable menu of customizable items and customizable features thereof;
presenting, via the display, a view of a selected customizable item and a customizable feature based on input received by the device;
receiving, via the input, order input with regard to the selected customizable item and customizable feature thereof;
transmitting, via the wireless network interface, order data including data representative of the selected customizable item and selected customizable feature thereof to an order data processing service;
receiving, via the input, at least one payment input command to provide payment for an order with regard to the received order input; and
transmitting, via the wireless network interface, the received payment data to a payment transaction processing service in response to receiving the at least one payment input command.

19. The device of claim 18, wherein the display is a visual output device for wear including a portion worn within a human line-of-sight.

20. The method of claim 19, wherein the device is a human-worn computing device that is worn about the head.
